(19) United States
(12) Patent Application Publication
(10) Pub. No.: US 2009/0204415 A1
(43) Pub. Date: Aug. 13, 2009

(54) System and method for product recall notification

(75) Inventor: Steven M. Baiera, Avon, NY (US)

Correspondence Address: HEWLETT-PACKARD COMPANY;Intellectual Property Administration, P.O. Box 272400, Fort Collins, CO, 80527-2400, US

(73) Assignee: Electronic Data Systems Corporation, Plano, TX (US)

(21) Appl. No.: 12/069,250

(22) Filed: Feb. 8, 2008

(51) Int. Cl. G06Q 10/00; G06Q 99/00

(52) U.S. Cl. 705/1

(57) ABSTRACT

A method for checking the recall status of a product. The method includes receiving product identification data in a data processing system by scanning a product. The method also includes storing the product identification data and checking the product identification data against a recall database. The method also includes determining whether the product has been recalled, and if the product has been recalled, notifying a user that the product has been recalled. There is also a method for managing product recalls. That method includes receiving product recall data including product identification data for a recalled product, and storing the product recall data in a recall database. That method also includes sending a notification to a user device according to the product recall data and subscription data.

### TECHNICAL FIELD

The present disclosure is directed, in general, to systems and methods for product recall notifications.

### BACKGROUND OF THE DISCLOSURE

Product recalls are important activities to ensure consumer safety. Often consumers are not aware of recalls impacting the products they have purchased and/or may have in their possession, or to which they may otherwise be exposed.

The timing of getting information to the consumer is can be very important when dealing with products such as foods, which if eaten could prove deadly to the consumer, and other products and consumables that can be revealed as dangerous after the consumer has begun using them.

### SUMMARY OF THE DISCLOSURE

One embodiment includes a method for checking the recall status of a product. The method includes receiving product identification data in a data processing system by scanning a product. The method also includes storing the product identification data and checking the product identification data against a recall database. The method also includes determining whether the product has been recalled, and if the product has been recalled, notifying a user that the product has been recalled.

Another embodiment includes a method for managing product recalls. That method includes receiving product recall data including product identification data for a recalled product, and storing the product recall data in a recall database. That method also includes sending a notification to a user device according to the product recall data and subscription data.

Another embodiment includes a recall notification system. The system includes a recall server configured to store product recall data in a recall database. The system also includes a notification system connected to send notifications to user devices according to the recalled product recall data. The recall server is configured to receive product identification data according to a product scanned by a product scanner and, in response, to indicate whether the product has been recalled.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIG. 2 depicts a block diagram of a system in accordance with a disclosed embodiment; and

FIG. 3 depicts a flowchart of a process in accordance with a disclosed embodiment.

### DETAILED DESCRIPTION

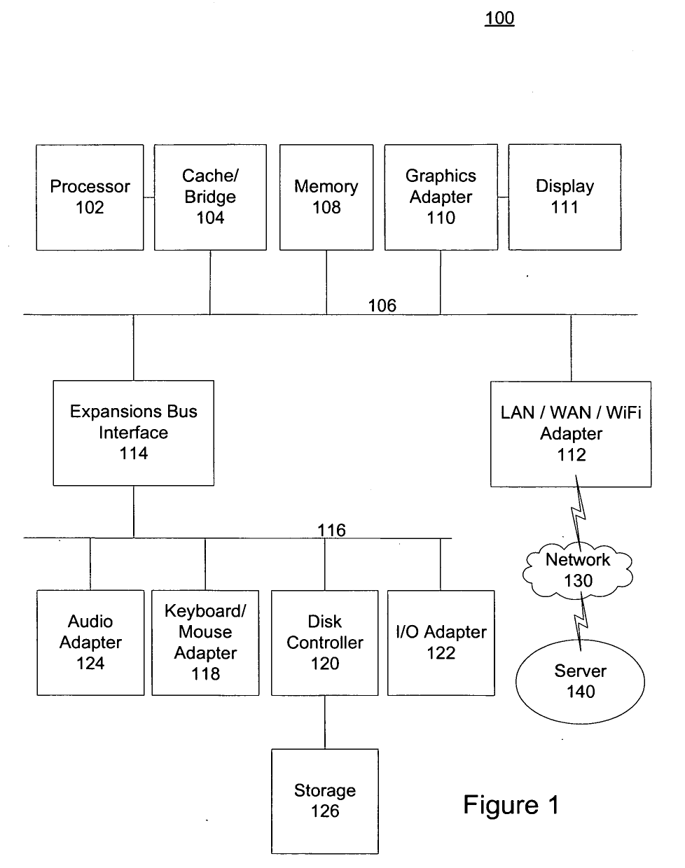

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

FIG. 1 depicts a block diagram of a data processing system in which an embodiment can be implemented. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (1/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

One disclosed embodiment provides the consumer with the ability to scan products in their home and to immediately alert them to any potential dangers based upon a database of product recalls. In various embodiments, the scanning can take place when a product is purchased or just prior to when it is going to be utilized or consumed.

In various embodiments, the scanning can include the scanning of a barcode or the passive scanning/reading of a RFID tag.

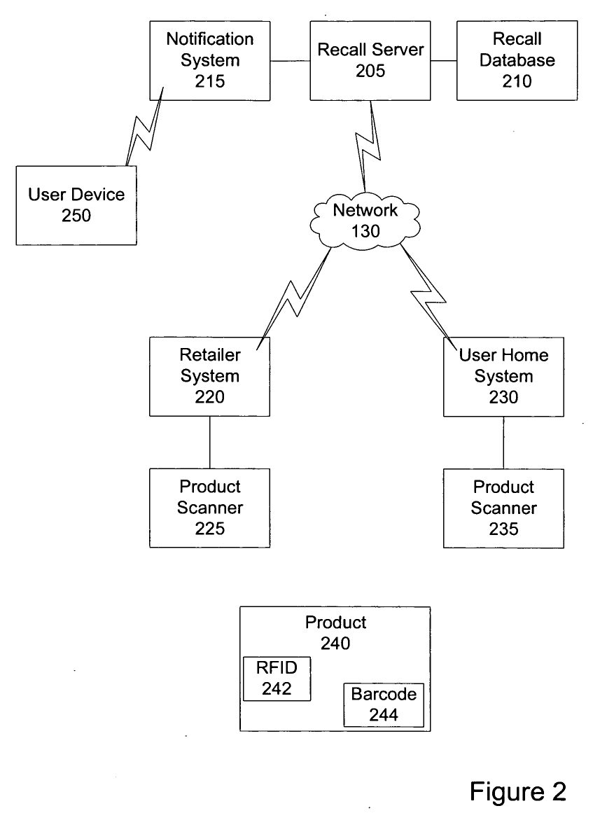

FIG. 2 depicts a block diagram of a system in accordance with a disclosed embodiment. In this figure, recall server 205 includes or communicates with a recall database 210, which stores product recall data. Preferably, the recall database is constantly or regularly updated by manufacturers, product testing agencies, and others, so that it contains real-time product recall data of all known product recalls. Recall server 205 is connected to communicate with network 130.

In some embodiments, recall server 205 also communicates with notification system 215, which can communicate with many user devices 250. A user device 250 can be any user device, including in particular mobile devices such as telephones, smartphones, and mobile computers, user home computers, and other devices. Notification system 215 can then send product recall information to user device 250, via email, page, text message, or any other known messaging technique.

Recall server 205 communicates over network 130 to be accessed by retailers 220 and user home systems 230. Recall server 205, notification system 215, retailer system 220 and user home system 230 can each be implemented as a data processing system 100.

While in a typical implementation, there would be many retailers 220, only one is depicted in FIG. 2 for the sake of clarity. Retailer system 220 is connected to communicate with a product scanner 225, e.g. via I/O adapter 122. Retailer system can be implemented as a point-of-sale (POS) system, or as a network of data processing systems including one or more POS system.

Product scanner 225 is capable of scanning a product 240 to identify the product, such as by identifying the make and/or model number of the product or other similar product identification data. Product scanner 225 can be a barcode scanner or a radio-frequency identification (RFID) scanner, or other known type of scanner, as appropriate. In alternate embodiments, instead of scanning a product 240 using product scanner 225, a user can manually enter product identification data into retailer system 220.

User home system 230 also communicates with a product scanner 235, e.g. via I/O adapter 122. Product scanner 235 is capable of scanning a product 240 to identify the product, such as by identifying the make and/or model number of the product or other similar product identification data. Product scanner 235 can be a barcode scanner or an RFID scanner, or other known type of scanner, as appropriate. In alternate embodiments, instead of scanning a product 240 using product scanner 235, a user can manually enter product identification data into user home system 230.

Product 240 can be any product, including a pharmaceutical, a consumer hard good, a consumable good or food product, or any other product which could be recalled. The product 240 includes some product identification data, for example in a label on the product or packaging, and can have, in particular, an RFID tag 242 and/or a barcode 244 that includes product identification data and can be read by product scanner 225 or product scanner 235.

Either or both of retailer system 220 and user home system 230 can maintain its own local recall database in storage 126. Any local recall database can be regularly or constantly updated from recall database 210 and recall server 205.

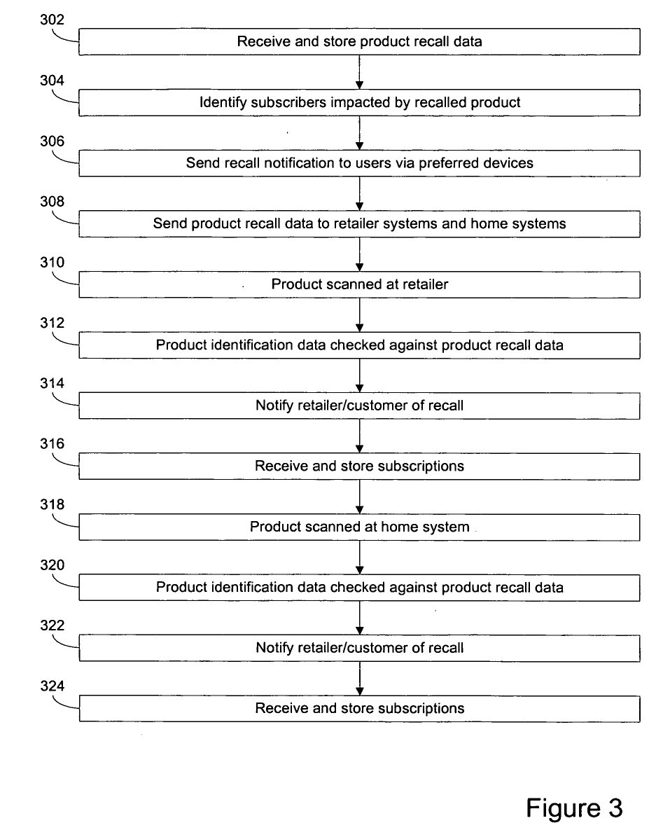

FIG. 3 depicts a flowchart of a process in accordance with a disclosed embodiment. Those of skill in the art will recognized that not every step discussed below need be performed in every instance, nor do the steps necessarily need to be performed in the particular order listed in every case, unless a specific step or ordering is described or claimed as required. Indeed, in some embodiments, some steps are omitted, or others are performed in a different order or concurrently with other steps.

At step 302, recall server 205 receives product recall data and stores it in recall database 210. The product recall data, in this example, indicates a recall of a product that can be identified by product identification data.

At step 304, notification system 215 identifies subscribers that have registered for recall notifications of a product corresponding to the product identification data and now indicated by the recall database 210 as recalled. The subscribers can be individual consumers, retailers, news agencies, or any others that are interested in tracking product recalls.

At step 306, notification system 215 sends a recall notification for the product, listing the product identification data, to the user devices 250 of the affected subscribers.

At step 308, recall server 205 sends the product recall data to the retailer systems 220 and the user home systems 230. This can be performed on a “push” basis when new product recall data is received, or when the recall server 205 receives a request for updated product recall data from the retailer systems 220 or the user home systems 230.

At step 310, a product 240 is scanned at retailer system 220 by product scanner 225 to determine product identification data. This can be performed when the retailer is performing an inventory check, or when the retailer is completing a purchase at a POS system. Alternatively, the data can be entered manually into, and received by, the retailer system 220.

At step 312, the product identification data is checked against the product recall data, either in a local copy of the product recall database, or by communicating a request to the recall server 205 for verification against the recall database 210.

At step 314, if a recall of the product is identified in a recall database, then the retailer and/or customer is informed of the recall, and the customer or retailer may choose not to complete the purchase transaction.

At step 316, if no current recall of the product is identified in the recall database, the retailer and/or customer is given the opportunity to subscribe to notifications for the product, and any subscriptions are transmitted to the notification system, including appropriate identification of the subject product and the user device 250 to be notified. Note that the subscription can be, in some embodiments, a pay service.

At step 318, a product 240 is scanned at user home system 230 by product scanner 235 to determine product identification data. This can be performed at any time convenient to the user, or it may be completed passively by a device such as an RFID scanner.

At step 320, the product identification data is checked against the product recall data, either in a local copy of the product recall database, or by communicating a request to the recall server 205 for verification against the recall database 210.

At step 322, if a recall of the product is identified in a recall database, then the user is informed of the recall.

At step 324, if no current recall of the product is identified in the recall database, the user is given the opportunity to subscribe to notifications for the product, and any subscription data are transmitted to the notification system, including appropriate identification of the subject product and the user device 250 to be notified. Note that the subscription can be, in some embodiments, a pay service. The subscription data is stored in the notification system, or alternately, in the recall database 210.

According to disclosed embodiments, a user or customer can be alerted to product recalls at any time the product is scanned, whether at purchase or at a later time at the user's convenience. Further, if a user has subscribed to updates for recalls of a particular product, the user can be actively notified anytime a recall of the product is entered into the recall database, by the notification system sending notifications according to the product recall data and the subscription data.

According to various embodiments, if a user scans a product when it is purchased and the product is subsequently recalled then the notification system 215 could send a page, text message, or email to the user.

In some embodiments, the product identification data includes product manufacturing batch information, encoded in a barcode, stored in an RFID tag, or otherwise. Batch information can be valuable for determining specific recalled items.

In some embodiments, when a product is recalled, the notification system 215 can immediately notify retailers via user devices 250, or the recall server can immediately notify retails systems 220. Once notified, electronic signage or tags at the retailer can be automatically updated to notify the consumer (in some cases, the signage or tags can be the user device described above). Additionally, the sale of certain recalled items could then be blocked at the point of sale. In this way, there need not be a delay for a retailer to manually process the recall data before the customers are protected. This embodiment can make use of electronic tags or signs that are already in place, and can enable stopping the sale at the POS.

In some embodiments, the consumer can opt into a service where their purchases are automatically recorded at the point of purchase by the store. These purchases are then tracked and the consumer is notified of any recalls. This service can be associated with the data maintained with “customer loyalty” cards or tied to credit card transactions.

In some embodiments, purchased consumable products can be tracked for a period of time corresponding to their “Use by Date”. After this time, the user can be informed that the product will no longer be tracked, and advised not to consume any remaining outdated product. The user may opt not to receive these additional status messages from the recall service.

Those skilled in the art will recognize that, for simplicity and clarity, the full structure and operation of all data processing systems suitable for use with the present disclosure are not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art. U.S. Pat. No. 6,513,017 is hereby incorporated by reference.

It is important to note that while the disclosure includes a description in the context of a fully functional system, those skilled in the art will appreciate that at least portions of the mechanism of the present disclosure are capable of being distributed in the form of instructions contained within a machine usable medium in any of a variety of forms, and that the present disclosure applies equally regardless of the particular type of instruction or signal bearing medium utilized to actually carry out the distribution. Examples of machine usable or machine readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for checking the recall status of a product, comprising:
receiving product identification data in a data processing system by scanning a product;
storing the product identification data;
checking the product identification data against a recall database;
determining whether the product has been recalled; and
if the product has been recalled, notifying a user that the product has been recalled.

2. The method of claim 1, wherein scanning comprises scanning a barcode of a product.

3. The method of claim 1, wherein the scanning comprises reading an RFID tag of a product.

4. The method of claim 1, wherein the product identification data includes a make and model of a product.

5. The method of claim 1, wherein the product identification data includes a product manufacturing batch information.

6. The method of claim 1, wherein checking the product identification data against a recall database includes transmitting the product identification data over a network to a recall server.

7. The method of claim 1, wherein the scanning the product is performed by a retailer data processing system.

8. The method of claim 1, wherein the scanning the product is performed by a user home data processing system.

9. The method of claim 1, further comprising receiving subscription data and transmitting the subscription data to a notification system.

10. The method of claim 9, wherein the notification system sends notifications according to the subscription data when recall data corresponding to the product identification information is received.

11. A method for managing product recalls, comprising:
receiving product recall data including product identification data for a recalled product;
storing the product recall data in a recall database;
sending a notification to a user device according to the product recall data and subscription data.

12. The method of claim 11, receiving scanned product identification data over a network connection, and checking the scanned product identification data against the recall database.

13. The method of claim 11, further comprising transmitting the product recall data to a retailer data processing system.

14. The method of claim 11, further comprising transmitting the product recall data to a user home system.

15. The method of claim 11, wherein the product identification data includes a product manufacturing batch information.

16. The method of claim 11, wherein sending a notification includes sending a text message to a user device.

17. The method of claim 11, wherein sending a notification includes sending an electronic mail message to a user device.

18. The method of claim 1, further comprising receiving and storing subscription data identifying a product and a user device to be notified.

19. The method of claim 11, wherein sending a notification includes sending an electronic mail message to a user device.

20. A recall notification system, comprising:
a recall server configured to store product recall data in a recall database; and
a notification system connected to send notifications to user devices according to the recall product recall data,
wherein the recall server is configured to receive product identification data according to a product scanned by a product scanner and, in response, to indicate whether the product has been recalled.
